(19) United States
(12) Patent Application Publication
(10) Pub. No.: US 2004/0233613 A1
(43) Pub. Date: Nov. 25, 2004

(54) Electric double layer capacitor and electric double layer capacitor stacked body

(75) Inventors: Ryuichi Kasahara, Sendai-shi (JP); Masako Ohya, Sendai-shi (JP); Makoto Unno, Sendai-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NEC TOKIN Corporation, Sendai-shi (JP)

(21) Appl. No.: 10/846,769

(22) Filed: May 13, 2004

(30) Foreign Application Priority Data
May 20, 2003 (JP) 141837/2003

(51) Int. Cl. H01G 9/00

(52) U.S. Cl. 361/502

(57) ABSTRACT

In an electric double layer capacitor having a pair of collectors, a pair of polarizing electrodes interposed between the collectors and faced each other with a separator interposed between the polarizing electrodes, each collector has a metallic foil and a conductive polymer layer located between the metallic foil and the polarizing electrode. The conductive polymer layer is formed by conductive polymer identical with that of the polarizing electrode.

This application claims priority to prior Japanese application JP 2003-141837, the disclosure of which is incorporated herein by reference.

### BACKGROUND OF THE INVENTION

The present invention relates to an electric double layer capacitor and a stacked body thereof.

In general, an electric double layer capacitor uses, as a dielectric material, an electric double layer that is formed on an interface between a solid with electric charges and an electrolytic solution contacted with the solid and that is about several nanometers thick. Such an electric double layer has a capacity of several tens μF per 1 cm², and a significantly large capacity of from several hundreds to several thousands F can be accomplished by using, as an electrode, activated carbon having a surface area of several thousands m².

An electric double layer capacitor of the type described has the following characteristics and has been used in practice, and further researches thereof are being made for improving performance.

(1) Deterioration in capacity can be reduced during cycles of repeating charge and discharge.

(2) Large output power can be obtained immediately after startup in comparison to an ordinary battery.

A currently available electric double layer capacitor having a small size has such a structure that a separator formed with a porous sheet is held between a pair of collectors each of which is attached to a polarizing electrode layer mainly containing activated carbon formed on a surface thereof. An electrolytic solution is impregnated into each polarizing electrode and each periphery of the polarizing electrodes is sealed with a gasket. The constitutional element of the electric double layer capacitor having the above-mentioned structure is often referred to as a cell unit. Plural cell units are used in a stacked manner and they may be also formed in a coin shape by being housed in a metallic container and by being sealed with a cap and a gasket.

In order to accomplish a prescribed withstand voltage of an electric double layer capacitor, at least two of electric double layer capacitors are laminated or stacked in series in consideration of on the prescribed withstand voltage and are structured into an electric double layer capacitor-laminated body or stacked body.

An electric double layer capacitor and an electric double layer capacitor laminated or stacked body have thus far been used for purposes of using a relatively small electric current, such as backup of memory units. Recent expectations have been directed to applications of requiring a large electric current, such as energy regeneration in automobiles and uninterruptible power supply in electronic devices. In order to cause a large electric current to flow, it is required to make the electrode and the collector thin and to reduce Equivalent Series Resistance, which will be hereinafter referred to as ESR. Furthermore, with advance of miniaturization in electronic devices, an electric double layer capacitor is also increasingly required which is thin in thickness.

Moreover, the conventional electric double layer capacitor-stacked body is disadvantageous in that evaporation (dry-up) of a solvent of the electrolytic solution and leakage of liquid are caused to occur from an interface between a collector and a terminal plate and an interface between collectors of the adjacent electric double layer capacitors while the body is being used in a high temperature. This results in an increase of the ESR. In order to solve the disadvantage, pressurizing the electric double layer capacitors with the aforementioned terminal plate is effective but looseness takes place in the electric double layer capacitor with the lapse of time. As a result, dry-up and leakage of the liquid are caused to occur from the aforementioned interfaces and inevitably brings about an increase in ESR.

As a countermeasure therefor, JP-A 07-161589, which will be hereinafter referred to as Document 1 discloses that an adhesive is coated to maintain the adhesiveness at the interfaces. Specifically, a polarizing electrode is attached in Document 1, through a conductive adhesive layer, to a conductive material which may act as a separator or a collector. In addition, the polarizing electrode is formed by a carbon material composed of activated carbon, amorphous carbon, and expanded carbon while the conductive adhesive layer is formed by resin and expanded carbon. However, no consideration is made at all in Document 1 about a reduction of characteristics in collectors. Furthermore, it is noted in Document 1 that the conductive adhesive layer of resin and expanded carbon is coated on the polarizing electrode which includes amorphous carbon as a binder and which is fired or sintered. With this structure, it has been found out that adhesion between the polarizing electrode and the conductive adhesive layer is not sufficient enough to assure long life. Additionally, using such a conductive adhesive layer results in an increase of a production cost and a reduction of characteristics.

In the case where an adhesive is coated only on a part of the gasket in a similar manner, the same problems cannot be avoided.

Furthermore, when an acidic aqueous solution, such as sulfuric acid, is used as the electrolytic solution, a material of an elastomer series is usually used as the collector and is high in gas permeability. In consequence, such a material is liable to cause dry-up of the solvent of the electrolytic solution to occur due to the high gas permeability thereof, and the material itself is expensive.

### SUMMARY OF THE INVENTION

An object of the invention is to provide an electric double layer capacitor and an electric double layer capacitor-stacked body each of which is thin in thickness and can effectively avoid occurrence of dry-up from interfaces between collectors and terminal plates and from interfaces between adjacent electric double layer capacitors, without increase of production cost.

The invention has be made as a result of reconsidering constitutions of collectors and polarizing electrodes included in the electric double layer capacitor, and junction structures at interfaces, for attaining the aforementioned object.

According to one aspect of the present invention, there is provided an electric double layer capacitor which contains a pair of polarizing electrodes facing each other with a separator interposed therebetween, a pair of collectors facing each other with the pair of polarizing electrodes interposed therebetween, and a gasket disposed at a periphery of the pair of polarizing electrode. In the aspect of the present invention, each of the collectors comprises a metallic foil and an electro-conductive layer of a polymer material formed on one surface of the metallic foil. Each of the polarizing electrodes includes a polymer material identical with the polymer material of the electro-conductive layer.

According to another aspect of the present invention, there is provided an electric double layer capacitor-stacked body which contains a plurality or at least two of electric double layer capacitors stacked. In the another aspect of the present invention, each of the electric double layer capacitors contains a pair of polarizing electrodes facing each other with a separator interposed therebetween, a pair of collectors facing each other with the pair of polarizing electrodes interposed therebetween, and a gasket disposed at a periphery of the pair of polarizing electrode. Each of the collectors contains a metallic foil and an electro-conductive layer of a polymer material formed on one surface of the metallic foil. Each of the polarizing electrodes includes a polymer material identical with the polymer material of the electro-conductive layer.

According to still another aspect of the present invention, there is provided a method of manufacturing an electric double layer capacitor which comprises a separator, a pair of polarizing electrodes facing each other with the separator interposed therebetween, a pair of collectors faceing each other with the pair of the polarizing electrodes interposed therebetween, and a gasket disposed at a periphery of each polarizing electrode. In the aspect of the present invention, the method includes the steps of: pressing and bonding the gasket onto one surface of a metallic foil used as the collector with the metallic foil partially left uncovered with the gasket; obtaining first slurry by dispersing and dissolving first conductive polymer material into solvent; coating the first slurry onto a portion of the metallic foil uncovered with the gasket; drying the first slurry into a first conductive polymer layer; obtaining second slurry by dispersing and dissolving, into solvent, activated carbon and second conductive polymer material identical with the first conductive polymer material; coating the second slurry onto the first conductive polymer layer; drying the second slurry into the polarizing electrode to form a first lamina; preparing a second lamina identical in structure with the first lamina; facing the polarizing electrode of each of the first and the second laminas each other, with the separator interposed therebetween; and pressing and bonding each collector to the gasket to obtain a capacitor element.

### BRIEF DESCRIPTION OF THE DRAWINGS

FIG. 1 is a cross sectional view showing a conventional electric double layer capacitor;

FIG. 2 is a cross sectional view showing an example of a basic constitution of an electric double layer capacitor according to the invention;

FIG. 3 is a partially expanded cross sectional view of the electric double layer capacitor shown in FIG. 2;

FIG. 4 is a cross sectional view showing an example of an electric double layer capacitor of the invention having been sealed with a laminated film; and

FIG. 5 is a cross sectional view showing an example of an electric double layer capacitor stacked body of the invention having been sealed with a laminated film.

### DESCRIPTION OF THE PREFERRED EMBODIMENT

Before describing an embodiment of the invention, an electric double layer capacitor stacked body according to the conventional technique will be described with reference to FIG. 1 for facilitating comprehension of the invention.

As shown in FIG. 1, a conventional electric double layer capacitor 5 has a separator 7, a pair of polarizing electrodes 9 disposed with the separator 7 intervening therebetween, a pair of collectors 11 disposed with the polarizing electrodes 9 intervening therebetween, and a gasket 13 disposed at peripheries of the separator 7 and the polarizing electrodes 9, which constitute a cell unit 15. A terminal plate 17 is disposed in contact with the collector 11. In order for unification in terminology, hereinafter, the cell unit 15 is referred to as an electric double layer capacitor, and an element containing plural cell units stacked each other is referred to as an electric double layer capacitor stacked body.

The constitution of the electric double layer capacitor shown in FIG. 1 will be described in more detail. It is necessary that the polarizing electrode 9 is stable to the electrolytic solution, has electroconductivity and has a large specific surface area, and therefore, it is formed with powder activated carbon, activated carbon fibers, a material obtained by binding activated carbon with a binder, such as polytetrafluoroethylene, solidified activated carbon obtained by bonding activated carbon to polyacene and carbon, and the like.

The electrolytic solution is roughly classified into an aqueous solution series and an organic solvent solution series. Examples of the electrolyte therefor include sulfuric acid and sodium hydroxide for the aqueous solution series, and a quaternary ammonium salt for the organic solvent solution series. The separator necessarily withstands the electrolytic solution, and examples thereof include an electroinsulating film having high ion permeability, such as nonwoven fabric of glass fibers or polypropylene fibers and a porous film formed with a polyolefin series polymer material.

The collector 11 may be formed with a polymer material or an elastomer imparted with electroconductivity by carbon powder or the like in the case where the aqueous solution series electrolytic solution is used, and may be formed with a metallic foil in the case where the organic solvent solution series electrolytic solution is used.

The gasket 13 has such a function that the shape of the electric double layer capacitor is maintained, and the electrolytic solution is prevented from being leaked, and also has such a function that short circuit of the pair of collectors due to contact is prevented from occurring.

A terminal plate 17 for a lead wire is provided outside the collector 11. The terminal plate 17 is generally fixed to pressurize the electric double layer capacitor for decreasing the internal electric resistance of the electric double layer capacitor. Examples of the method for pressurizing include a method, in which the assembly is held by insulating pressurizing plates from both sides thereof, and fixed with nuts and bolts, and a method, in which the assembly is covered with a molded external cladding or a flexible film, such as a laminated film of plastics and a metallic foil, and after evacuating the interior, it is sealed to apply the atmospheric pressure.

The withstand voltage of the electric double layer capacitor depends on the electrolytic solution, and it is from 0.6 to 1.0 V in the case of the aqueous solution series, and is about from 2.0 to 3.0 V in the case of the organic solvent solution series while it varies on the species of the electrolyte used. In order to impart a prescribed withstand voltage to the electric double layer capacitor, plural electric double layer capacitors are stacked in series corresponding to the necessary withstand voltage, i.e., they are used as an electric double layer capacitor stacked body.

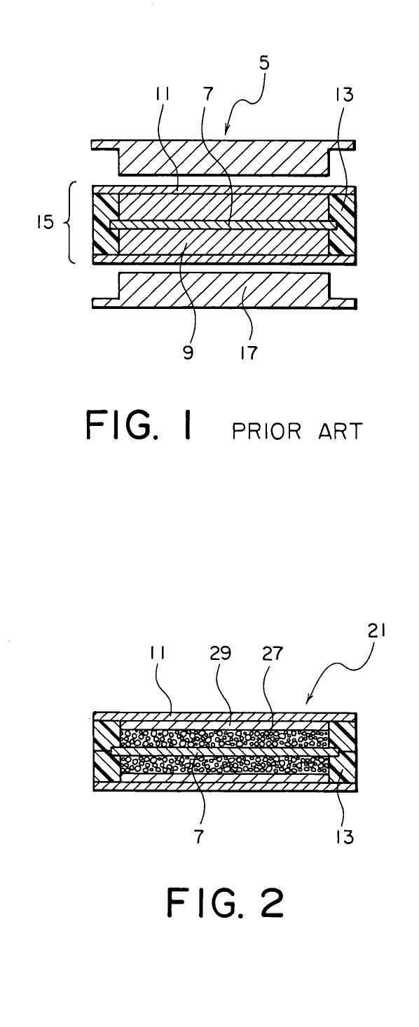

Embodiments of the invention will be described with reference to FIGS. 2 to 5.

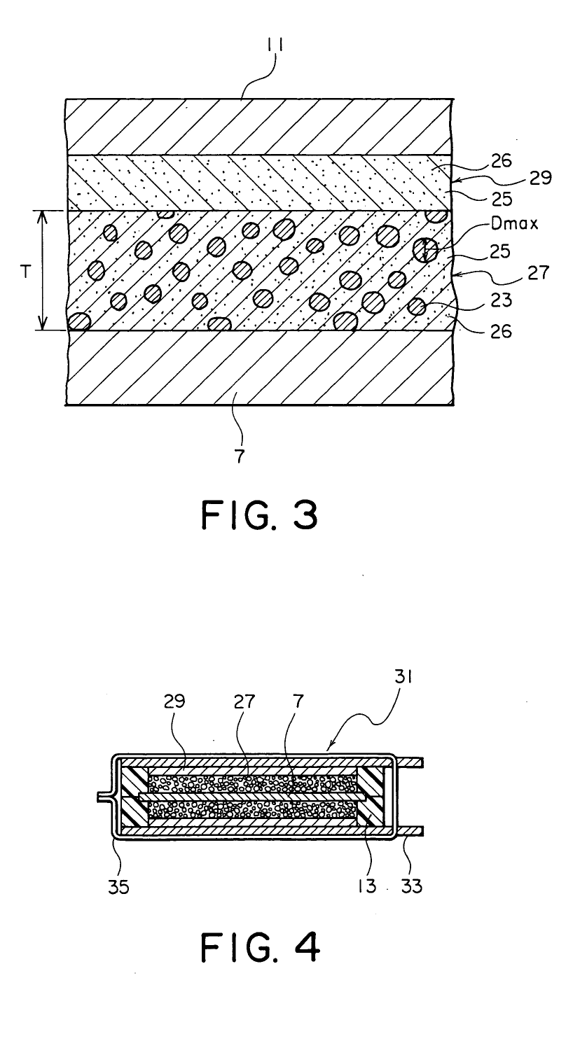

As shown in FIGS. 2 and 3, an electric double layer capacitor 21 has such constitution that has a separator 7, polarizing electrodes 27 that are formed with activated carbon 23 and a polymer material 25 imparted with electro-conductivity and hold the separator 7, collectors 11 formed with a metallic foil, electro-conductive polymer material layer 29 formed on the surfaces of the collectors 11 holding the polarizing electrodes, and a gasket 13 sealing the interior of the collectors 11.

The polarizing electrodes 27 and the polymer material layer 29 contain an electro-conductive polymer material similar to each other. The electro-conductive polymer material is made from a mixture of carbon black and olefin copolymer. The electro-conductive polymer layer is made by dispersing the mixture into solvent to form a slurry, applying the slurry to a surface of a collector 11 made of the metallic foil, and drying the slurry applied.

While each of the polarizing electrodes 27 is made by dispersing the mixture and the activated carbon into solvents to form a slurry, applying the slurry to a surface of the electro-conductive polymer layer formed on the surface of the corrector 11, and drying the slurry applied.

As shown in FIG. 4, the electric double layer capacitor 21 shown in FIG. 2 has a sealed structure 31 sealed with a laminated film 35. In this embodiment, the collectors 11 are extended to form terminal plates 33, and the part of the assembly other than the terminal plates 33 is sealed with a laminate film 35.

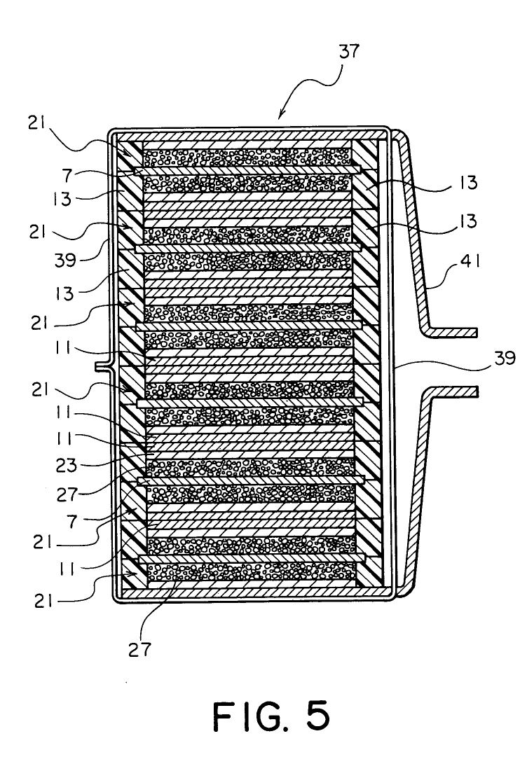

As shown in FIG. 5, an electric double layer capacitor stacked body 37 has such a constitution that has six electric double layer capacitors 21 stacked each other, which are then sealed with a laminated film 39. The collectors 11 positioned on both end surfaces in the accumulation direction of the stacked body are extended to form terminal plates 41, and the part of the assembly other than the terminal plates 41 is sealed with a laminated film 39.

The electric double layer capacitor and the electric double layer capacitor stacked body according to the invention will be described in more detail with reference to the following examples.

### EXAMPLE 1

Six electric double layer capacitors 21 shown in FIGS. 2 and 3 were stacked to produce an electric double layer capacitor stacked body 37 having the structure shown in FIG. 5. The polarizing electrode 27 was formed by binding activated carbon having a maximum particle diameter of 20 μm with a polymer material imparted with electroconductivity (hereinafter, referred to as an electro-conductive polymer) as a binder. The electro-conductive polymer was formed by mixing carbon black and an olefin copolymer at a volume ratio of 6/4.

Specific examples of the olefin copolymer include ethylene-propylene rubber, but it is not limited thereto. In this example, an electro-conductive polymer layer 29 having a thickness of 10 μm and the same composition as the binder for the polarizing electrode intervened between the polarizing electrode 27 and the collector 11.

The dimension of the polarizing electrode 27 was 12 mm×24 mm×25 μm. The separator 7 was formed with nonwoven fabric of fibers of a polytetrafluoroethylene series polymer and had a dimension of 14 mm×26 mm×25 μm. The gasket 13 and shaped into a frame form, was formed with a thermoplastic ionomer film and had an outer dimension of 18 mm×30 mm, an inner dimension of 12 mm×24 mm and a thickness of 95 μm.

An ionomer film largely varies in physical properties depending on chemical structure thereof. An ionomer having a softening point of 62° C. and a melting point of 88° C. was used herein. The collector 11 was formed with an aluminum foil and had a dimension of 12 mm×24 mm×25 μm, provided that those for the outermost layer had a dimension of 12 mm×24 mm×80 μm.

The production process will be specifically described. A gasket 13 was adhered to a metallic foil to be used as a collector 11 by pressing under heat, and a xylene solution of an olefin copolymer 25 containing carbon black 26 was then coated to a thickness of 10 μm after drying to form an electro-conductive polymer layer 29. On the coated surface, a slurry obtained by dispersing activated carbon 23, carbon black 26 and an olefin copolymer 25 in xylene was then coated to a thickness of 25 μm after drying to form a polarizing electrode 27.

Another stacked body containing the collector 11, the electro-conductive polymer layer 29 and the polarizing electrode 27 was prepared in the same manner, and the stacked bodies thus prepared were bonded in such a manner that the polarizing electrodes 27 face each other with a separator 7 intervening therebetween by pressing the collectors 11 and the gasket 13 under heat, so as to obtain an electric double layer capacitor. Six electric double layer capacitors thus prepared were stacked and bonded by pressing the gasket 13 under heat to obtain an electric double layer capacitor stacked body 37. The collectors 41 at both end surfaces of the electric double layer capacitor stacked body 37 had a different thickness from the others, to which an aluminum foil to be a lead part is attached to form terminal plates 41.

The electric double layer capacitor stacked body was sealed by covering the entire thereof other than the terminal plates 41 with a laminated film 39 having a three-layer structure having an ionomer layer as an adhesive layer and a polyethylene terephthalate layer as a protective layer with an aluminum foil intervening therebetween. In the electric double layer capacitor 21, the portions surrounded by the collectors and gaskets was previously impregnated with a sulfuric acid aqueous solution of a concentration of 40% by weight as an electrolytic solution.

### EXAMPLE 2

An electric double layer capacitor stacked body 37 was produced in the same manner as in Example 1 except that the activated carbon 23 used in the polarizing electrode 27 was changed to that having a maximum particle diameter of 10 μm.

### EXAMPLE 3

Electric double layer capacitor stacked bodies 33 were produced in the same manner as in Example 1 except that the thickness of the polarizing electrode 27 was changed to 30, 40, 50 and 60 μm.

### COMPARATIVE EXAMPLE 1

As a comparative example, an electric double layer capacitor stacked body 37 was produced in the same manner as in Example 1 except that activated carbon 23 having a maximum particle diameter of 20 μm was used, the thickness of the polarizing electrode 27 was changed to 20 μm, and the thickness of the gasket 13 was changed according to the thickness of the polarizing electrode 27.

### COMPARATIVE EXAMPLE 2

As another comparative example, electric double layer capacitor stacked bodies 33 were produced in the same manner as in Example 1 except that activated carbon having a maximum particle diameter of 30, 50, 80 or 100 μm, which exceeded the thickness of the polarizing electrode 27, was used.

### COMPARATIVE EXAMPLE 3

As still another comparative example, an electric double layer capacitor stacked body was produced in such a manner that the electro-conductive polymer layer 29 in FIGS. 4 and 5 was not formed, and the electro-conductive polymer, which was used in the polarizing electrode with activated carbon in Examples, was not used. In this comparative example, a slurry was prepared by mixing activated carbon used in Example 1, carbon black as an electro-conductive assistant and polyvinylidene fluoride as a binder in a weight ratio of 80/10/10 with a solvent, and it was coated to form a polarizing electrode having a thickness of 25 μm.

An electric double layer capacitor stacked body was produced in the same manner as in Example 1 except that the aforementioned polarizing electrode 27 was used, no electro-conductive polymer layer 29 was provided, the thickness of the gasket 13 was changed corresponding thereto, and the terminal plates 35 were provided as separate structures. The terminal plate 41 was a tinned copper plate having an electro-conductive layer on one surface thereof formed with silver paste, and was attached to the end surface of the stacked body in such a manner that the electro-conductive layer faced the collector.

The electric double layer capacitor stacked bodies 37 of Examples and Comparative Examples were measured for ESR immediately after production and ESR after applying a load of a voltage of 5.4 V at 60° C. for 1,000 hours. The ESR was obtained by measuring an electric current and a phase contrast by applying an alternate current voltage of 1 kHz and 10 mVrms. The electric double layer capacitor before accumulation was also measured for weight before and after application of the voltage load to investigate the diminution of the electrolytic solution. The measurement results of Examples and Comparative Examples are collectively shown in Table 1 below.

TABLE 1

| | MAXIMUM | | ESR [mΩ] | | |
|---|---|---|---|---|---|
| | PARTICLE | THICKNESS | BEFORE | AFTER | |
| | DIAMETER OF | OF | APPLICA- | APPLICA- | WEIGHT |
| | ACTIVATED | POLARIZING | TION OF | TION OF | DIMINU- |
| | CARBON | ELECTRODE | VOLTAGE | VOLTAGE | TION |
| | [μm] | [μm] | LOAD | LOAD | [mg] |
| EXAMPLE | 20 | 25 | 106 | 111 | 7 |
| 1 | | | | | |
| EXAMPLE | 10 | 25 | 104 | 108 | 5 |
| EXAMPLE | 20 | 30 | 105 | 111 | 6 |
| 3 | | 40 | 110 | 117 | 8 |
| | | 50 | 117 | 122 | 7 |
| | | 60 | 132 | 138 | 7 |
| COMPARA- | 20 | 20 | 102 | 361 | 8 |
| TIVE | | | | | |
| EXAMPLE | | | | | |
| 1 | | | | | |
| COMPARA- | 30 | 25 | 106 | 257 | 6 |
| TIVE | 50 | | 108 | 569 | 6 |
| EXAMPLE | 80 | | 112 | 1126 | 8 |
| 2 | 100 | | 116 | 1642 | 6 |
| COMPARA- | 20 | 25 | 145 | 859 | 106 |
| TIVE | | | | | |
| EXAMPLE | | | | | |
| 3 | | | | | |

It is understood from the results shown in Table 1 that there is no significant difference in ESR before and after application of the voltage load in the case where the maximum particle diameter of the activated carbon is smaller than the thickness of the polarizing electrode 27. However, it is understood from the results of Comparative Examples 1 and 2 that in the case where the maximum particle diameter of the activated carbon 23 is equal to or more than the thickness of the polarizing electrode 27, the ESR after application of the voltage load is significantly increased associated with increase of the maximum particle diameter of the activated carbon 23.

The electric double layer capacitor stacked body 37 of Comparative Example 2 was disassembled and inspected after application of the voltage load, and such parts were found that activated carbon particles having a larger diameter were in contact with the aluminum foil constituting the collector 11 to corrode the aluminum foil. It is understood therefore that the electro-conductive polymer layer 29 has such a function that the aluminum foil is prevented from being corroded with the electrolytic solution, but in the case where the particle diameter of the activated carbon 23 is too large, it consequently breaks the electro-conductive polymer layer 29 to cause increase in ESR through corrosion of the aluminum foil.

In the case where the thickness of the polarizing electrode 27 is increased without change of the maximum particle diameter of the activated carbon 23, there is no significant difference in ESR before and after application of the voltage load, but the ESR before application of the voltage load is increased with the increase of the thickness of the polarizing electrode 27. Therefore, the thickness of the polarizing electrode is preferably about 50 μm or less under the conditions.

It is found from the comparison between Comparative Example 3 and Examples that there is a large difference in weight diminution, and it is understood that the solvent of the electrolytic solution, i.e., water, is remarkably evaporated in Comparative Example 3 as compared to Examples. As a result, significant increase in ESR after application of the voltage load is also found in Comparative Example 3. In Comparative Example 3, furthermore, liquid leakage of 14% was found, which was assumed to be caused by the absence of the electro-conductive polymer layer 29.

It is considered that this is because Examples used the aluminum foil used as the collector as the terminal plate, and thus permeation of vapor of the solvent of the electrolytic solution is prevented by the aluminum foil in Examples, but prevention of permeation of vapor of the solvent of the electrolytic solution is insufficient in Comparative Example 3 due to the silver paste layer intervening between the polarizing electrode and the terminal plate. It is also considered that the electro-conductive polymer layer 29 contributes to prevention of permeation of the electrolytic solution at the interface between the gasket 39 and the collector 11.

The comparison in ESR before application of the voltage load between Examples and Comparative Example 3 shows that Comparative Example 3 exhibits a larger value than all Examples. It is considered that this is because the polarizing electrode 27 of the Examples has activated carbon 23 formed with the electro-conductive polymer as a binder, and therefore, the electric resistance among activated carbon is decreased.

While nonwoven fabric of fibers of a polytetrafluoroethylene series polymer is used as the separator 7 in Examples, the similar effect can be obtained when other porous polyolefin series film, glass fibers, acrylic fibers and the like are used. While the electro-conductive polymer used in Examples is formed by dispersing carbon black 26 in an olefin copolymer 25, the similar effect can be obtained by using other electro-conductive elastomer and the like as far as those materials can realize the equivalent internal resistance.

The materials constituting the other members are also not limited to those used in Examples. While an ionomer film is used as the gasket 13 in Examples, it is not limited thereto as far as those materials have thermal plasticity. While an aluminum foil is used as a metallic foil constituting the collector 11, 33, 41, it is not limited thereto, and other metallic foils can be used as far as those has the equivalent resistance and strength.

As described in the foregoing, according to the invention, such an electric double layer capacitor and an electric double layer capacitor stacked body can be obtained without increase in production cost, that cause no dry-up of the solvent of the electrolytic solution, and are suppressed in increase of ESR upon using at high temperatures associated thereto.

While the invention has been described with reference to the examples, the invention is not construed as being limited thereto, and various changes and modifications can be made therein without departing from the spirit and scope of the invention.

What is claimed is:

1. An electric double layer capacitor comprising a pair of polarizing electrodes facing each other with a separator interposed therebetween, a pair of collectors facing each other with the pair of polarizing electrodes interposed therebetween, and a gasket disposed at a periphery of the pair of polarizing electrode,
each of the collectors comprising a metallic foil and an electro-conductive layer of a polymer material formed on one surface of the metallic foil,
each of the polarizing electrodes including a polymer material identical with the polymer material of the electro-conductive layer.

2. An electric double layer capacitor as claimed in claim 1, wherein the polymer material includes olefin copolymer.

3. An electric double layer capacitor as claimed in claim 1, wherein each polarizing electrode further comprises activated carbon.

4. An electric double layer capacitor as claimed in claim 1, wherein each polarizing electrode comprises:
at least one mixture layer of activated carbon and the polymer material.

5. An electric double layer capacitor as claimed in claim 1, wherein each polarizing electrode comprises;
an activated carbon layer and a mixture layer which comprises a mixture of activated carbon and the polymer material and which is attached to the electro-conductive layer of each collector.

6. An electric double layer capacitor as claimed in claim 3, wherein the activated carbon has a maximum particle size smaller than a thickness of the polarizing electrode.

7. An electric double layer capacitor as claimed in claim 4, wherein the activated carbon included in the at least one mixture layer has a maximum particle size smaller than a thickness of the polarizing electrode.

8. An electric double layer capacitor as claimed in claim 5, wherein the activated carbon included in each of the activated carbon layer and the mixture layer has a maximum particle size smaller than a thickness of each of the activated carbon layer and the mixture layer.

9. An electric double layer capacitor as claimed in claim 1, wherein each of the collectors is operable as a terminal plate.

10. An electric double layer capacitor-stacked body comprising a plurality of electric double layer capacitors stacked,
each of the electric double layer capacitors comprising a pair of polarizing electrodes facing each other with a separator interposed therebetween, a pair of collectors facing each other with the pair of polarizing electrodes interposed therebetween, and a gasket disposed at a periphery of the pair of polarizing electrode,
each of the collectors comprising a metallic foil and an electro-conductive layer of a polymer material formed on one surface of the metallic foil,
each of the polarizing electrodes including a polymer material identical with the polymer material of the electro-conductive layer.

11. An electric double layer capacitor-stacked body as claimed in claim 10, wherein the polymer material includes olefin copolymer.

12. An electric double layer capacitor-stacked body as claimed in claim 10, wherein each of the polarizing electrode comprises activated carbon.

13. An electric double layer capacitor-stacked body as claimed in claim 12, wherein the activated carbon has a maximum particle size smaller than a thickness of the polarizing electrode.

14. An electric double layer capacitor-stacked body as claimed in claim 10, wherein the collectors positioned on both end surfaces of the stacked body function as terminal plates.

15. A method of manufacturing an electric double layer capacitor which comprises a separator, a pair of polarizing electrodes facing each other with the separator interposed therebetween, a pair of collectors facing each other with the pair of the polarizing electrodes interposed therebetween, and a gasket disposed at a periphery of each polarizing electrode, the method comprising the steps of:
pressing and bonding the gasket onto one surface of a metallic foil used as the collector with the metallic foil partially left uncovered with the gasket;
obtaining first slurry by dispersing and dissolving first conductive polymer material into solvent;
coating the first slurry onto a portion of the metallic foil uncovered with the gasket;
drying the first slurry into a first conductive polymer layer;
obtaining second slurry by dispersing and dissolving, into solvent, activated carbon and second conductive polymer material identical with the first conductive polymer material;
coating the second slurry onto the first conductive polymer layer;
drying the second slurry into the polarizing electrode to form a first lamina;
preparing a second lamina identical in structure with the first lamina;
facing the polarizing electrode of each of the first and the second laminas each other, with the separator interposed therebetween; and
pressing and bonding each collector to the gasket to obtain a capacitor element.

16. A method as claimed in claim 15, wherein the first and the second conductive polymer material includes olefin copolymer.

17. A method as claimed in claim 15, further comprising the steps of:
covering the electric double layer capacitor with a laminate film, with the collectors partially projected through the laminate film; and
using projected portions of the collectors as terminal plates of the electric double layer capacitor.

18. A method as claimed in claim 15, further comprising the steps of:
preparing a plurality of the capacitor elements; and
stacking the capacitor element one another to form a capacitor-stacked body.

19. A method as claimed in claim 18, further comprising the steps of:
covering the capacitor-stacked body with a laminate film, with outmost collectors partially projected through the laminate film; and
using projected portions of the collectors as terminal plates of the electric double layer capacitor.
